(19) United States
(12) Patent Application Publication
(10) Pub. No.: US 2004/0255626 A1
(43) Pub. Date: Dec. 23, 2004

(54) Locking method and locking device for a mobile element

(76) Inventors: Tim Petasch, Bremen (DE); Reiner Baumgarte, Bremen (DE); Jorg Meyer-Schurmann, Sage (DE); Matthias Lange, Osterholz-Scharmbeck (DE); Wolfgang Neumann, Nordenham (DE); Herbert Claassen, Bremen (DE)

Correspondence Address: WILLIAM COLLARD, COLLARD & ROE, P.C., 1077 NORTHERN BOULEVARD, ROSLYN, NY, 11576, US

(21) Appl. No.: 10/868,442

(22) Filed: Jun. 10, 2004

(30) Foreign Application Priority Data
Jun. 12, 2003 (DE) 103 26 416.7

(51) Int. Cl. B60R 25/04

(52) U.S. Cl. 70/241

(57) ABSTRACT

A mobile locking element and a method for unlocking a mobile element via the mobile locking element interacting with the mobile element, the method comprising the following steps:

a) exerting a pressure on the mobile element in the direction of the locking device;

b) moving the mobile element thus triggered out of a locking position with the locking element, so that an interaction between the mobile element and the locking element is removed;

c) operating a switch element caused by the exertion of pressure on the mobile element; and

d) moving the mobile locking element, triggered by the operation of the switch element, into a position in which no renewed locking takes place when the mobile element moves back. The movement of the mobile locking element takes place while it is not in interaction with the mobile element, so that frictional and shearing forces are minimized. In this way, a locking device can be operated in a particularly force-free and wear-free manner, so that the method can be carried out with very small motorized components.

### BACKGROUND OF THE INVENTION

1. Field of the Invention

The invention relates to a locking method for the locking of a mobile element, in particular a flap or a drawer, and a locking device for the mobile element, which can be in a closed or in an opened position. The locking device has a mobile locking element for locking the mobile element in its closed position.

2. The Prior Art

Such swivelling flaps, which as a rule are fixed at one side or linked at one side, are important especially in the automotive sector, whereby electromechanical locking devices are used. Such flaps are, for example, tank flaps, rear flaps, gloveboxes and engine compartment flaps.

Known closing devices for such flaps are generally equipped with direct-current motors, gear stages and drive elements, in order to ensure that shearing forces and shearing moments in the locking mechanism can be overcome, and in order to maintain reserve capacities to be able to compensate for negative influences, such as temperature, corrosion, aging and wear. The closing devices used hitherto are therefore usually overdimensioned measured against the technical problem and are therefore very expensive and cost-intensive.

### SUMMARY OF THE INVENTION

It is therefore an object of the invention to provide a locking method and a locking device of the type mentioned above, which permit a reliable operation, with a simple design and the possibility of cost-effective production of the locking device.

This and other objects are accomplished according to the invention by a method for unlocking a mobile element via a mobile locking element interacting with the mobile element, having the following features:

a) exertion of a pressure on the mobile element in the direction of the locking device;

b) movement of the mobile element thus triggered out of a locking position with the locking element, so that an interaction between the mobile element and the locking element is removed;

c) operation of a switch element caused by the exertion of pressure on the mobile element; and

d) movement of the mobile locking element, triggered by the operation of the switch element, into a position in which no renewed locking takes place when the mobile element moves back, whereby the movement of the mobile locking element takes place while it is not in interaction with the mobile element, so that frictional and shearing forces are minimized.

In this way, a locking device can be operated with the method according to the invention in a particularly force-free and wear-free manner, so that the method can be carried out with very small motorized components.

In step c), the exertion of pressure preferably takes place for a predetermined duration in order to operate the switch element, to ensure that a conscious and not merely chance exertion of pressure triggers the operation of the switch element. Inadvertent openings are thus avoided. Furthermore, it is advantageous for the mobile element to be held only for a predetermined duration in the position in which no renewed locking takes place during the return movement of the locking device. The effect of this is that, after the opening of the mobile element, the locking element returns to its initial position and is ready for a renewed locking of the mobile element in the locking device.

In another preferred development of the method according to the invention, a detection is carried out to establish whether the mobile element is locked or not, i.e. opened, in the locking device. This information is preferably passed on to a central control point and can be evaluated and displayed there.

The locking device has a mobile locking element for the locking of the mobile element in its closed position. It is essential to the invention that a switch element is provided, which is actuated when pressure is exerted on the mobile element, and that the locking element is designed in such a way that, when pressure is exerted on the mobile element, a mechanical contact between the locking element and the mobile element is removed. It is also essential that the switch element is in a signal-connection with an actuator in such a way that the actuator is actuated when the switch element is operated, so that the locking element changes between a locking position and a release position. A particularly simple design is possible with this closing device, since the mobile element or flap first has to be moved in order to trigger the switch element, so that the switch element then actuates the actuator, which brings the locking element into the release position, so that the flap can then be swivelled up. Since the flap is moved first, and moved in such a way that the locking element is no longer in active connection with the flap or a locking pin assigned to the flap, the locking element can thereafter be moved particularly easily, without shearing forces or other frictional forces arising due to contact with the flap having to be overcome. The actuator can be a motor, a gear motor, a combination of spring devices or an element exerting force in another way, which makes it possible to move the locking element from the locking position into the release position and vice versa. The switch element is preferably a component of the locking device and is in active connection with the mobile element in such a way, i.e. is positioned in such a way, that it is actuated when pressure is exerted on the mobile element.

It is preferable, however, to assign to the mobile locking element a spring device which holds the locking element in a locking position and also to use an actuator which is in active connection with the locking element in such a way that the actuator brings the locking element into a release position against the force applied by the spring device. In such a closing device, a particularly simply designed actuator which has to exert a force only in one direction can be used.

In order to close the flap, it is possible in a preferred development to press the flap shut manually until the flap comes into active connection with the switch element, so that the actuator is actuated and releases the locking element, so that the locking element can again be changed into the locking position.

Preferably, however, a switch is provided which, when the switch element is operated, activates the actuator only for a predetermined duration, so that the locking element is in the release position for the predetermined duration. Thereafter, the locking element automatically changes again into the locking position, so that, when the flap is pressed shut, it can be latched directly into the locking element.

The switch element can be provided in a large number of different variations. An electric, electromagnetic or optical detection can for example take place indicating that the swivelling flap has been brought into a certain position. The design of the switch element as a contact switch which is operated by the flap is mechanically simple and reliable. The switch element, in particular the contact switch, is preferably connected with a circuit, which delivers an activation signal for the actuator only after a predetermined duration of sustained pressure on the contact switch. In this way, inadvertent opening by a chance or unintentional contact with the flap is eliminated. Furthermore, it is preferable for the circuit assigned to the contact switch to be set to a predetermined duration that corresponds approximately to the predetermined duration to which the circuit assigned to the actuator is set. The effect of this is that chance contacts during opening are eliminated and the flap has to be pressed for a duration, of for example approx. 1 second, in order to achieve a release. The switching time of the actuator is roughly in the same order of magnitude, so that within this time, which corresponds to a conscious and intentional operation, the flap can be opened and thereafter the actuator again releases the locking element and the latch-type locking described above can take place.

The actuator is designed as an electromagnet in a preferred development of the invention. The closing device thus completely dispenses with a motor and can be produced particularly simply and cost-effectively. In another preferred embodiment of the invention, the locking device is designed in an assembly with the switch element, in particular the contact switch, and the actuator. The closing device can therefore be mounted as an element in or on the flap. According to another preferred development of the invention, the actuator is in a circuit connection with the central locking and/or a further optional control device. The circuit assigned to the actuator is preferably designed in such a way that, when the central locking is closed, operation of the actuator and thus opening of the lid is eliminated. Operation of the actuator and thus opening of the lid is enabled again only when the central locking is released.

The switch element of the closing device, in particular the contact switch, is preferably positioned in such a way that it can be operated by a locking pin arranged on the flap. It is advantageous for the flap to be in connection with a spring device, which holds the flap in an opened position, so that the locking pin of the flap is latched in the closed position and is pressed into this latched position. Only when the operator applies a force directed against the spring force and presses the flap somewhat inwards is the locking pin arranged on the flap able to operate the contact switch, whereby the locking pin simultaneously leaves the latched position and the locking element of the locking device is moved, after operation of the contact switch, with negligibly small shearing and frictional forces.

In a preferred development, the locking element is capable of swivelling about a point of rotation. The locking element can be swivelled about the rotation point at one time into a locking position and at another time into a release position. The locking element is connected in an end area with the spring device which pulls the locking element, in particular the end of the locking element lying opposite the end area with the spring device, into the locking position. There is preferably arranged on the locking element a hook element for engagement in a locking pin fixed to the flap. This locking pin preferably also has a hook, which is designed to engage in the hook element. The hook of the locking pin and the hook element of the locking element have defined sliding surfaces, which make it possible for the hook element of the locking element to be pressed from the dipping locking pin of the flap over the defined sliding surfaces to the side until it snaps in, i.e. they hook into one another.

In a further development of the invention, an additional sensor is provided, which detects whether the mobile element is in the closed or in the opened position. The sensor is preferably designed as an additional switch or as a second switch element or as a contact switch, which is arranged beside the first switch element. This second switch element triggers when the mobile element is in the closed position. When pressure is exerted on the closed element and there is a slight movement in the direction of the locking device, there is also operated, apart from this second switch element, the first switch element described at the outset, which triggers the actuator. In this way, additional status information is obtained, which can be evaluated and displayed in a central control. The design of this sensor can also take place in various other ways.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a tank cap with a locking device in the closed position;

FIG. 2 shows a tank cap with a locking device in the opened position;

FIG. 3 shows a diagrammatic representation of the opening process in three positions following one another chronologically;

FIG. 4 shows a diagrammatic representation of the closing process in three positions following one another chronologically; and

FIG. 5 shows a diagram of the switch durations occurring during the opening process.

### DETAILED DESCRIPTION OF THE PREFERRED EMBODIMENT

Referring now in detail to the drawings, FIG. 1 shows a schematic diagram of a closing device according to the invention with a flap 1, which is designed as a tank cap, and a locking device 2. Flap 1 is secured in a swivelling manner at the left-hand side in the Figure about a mounting 3, or more precisely rotatably about an axle running through the mounting. A spring device is provided, which preloads flap 1 against the direction of arrow 6. Flap 1 has in the right-hand end area, i.e. in the freely swivelling end area, a locking pin 4 with a hook 5 arranged at the end of the locking pin. Hook 5 is designed for engagement in locking device 2, more precisely in a hook element 16 of a locking element 10. Locking device 2 has a locking element 10 capable of swivelling about an axle 14, said locking element being marked here with reference number 10 in its locking position and with 10a in its release position which is also represented. Locking device 2 further has an actuator 12 designed as an electromagnet and a contact switch 11. The locking device is arranged in an assembly in a two-part housing. First housing part 18 accommodates switch element 11, locking element 10 and actuator 12. Second housing part 13 surrounds in particular actuator 12 from top to bottom and forms axle 14 for the swivelling motion of locking element 10.

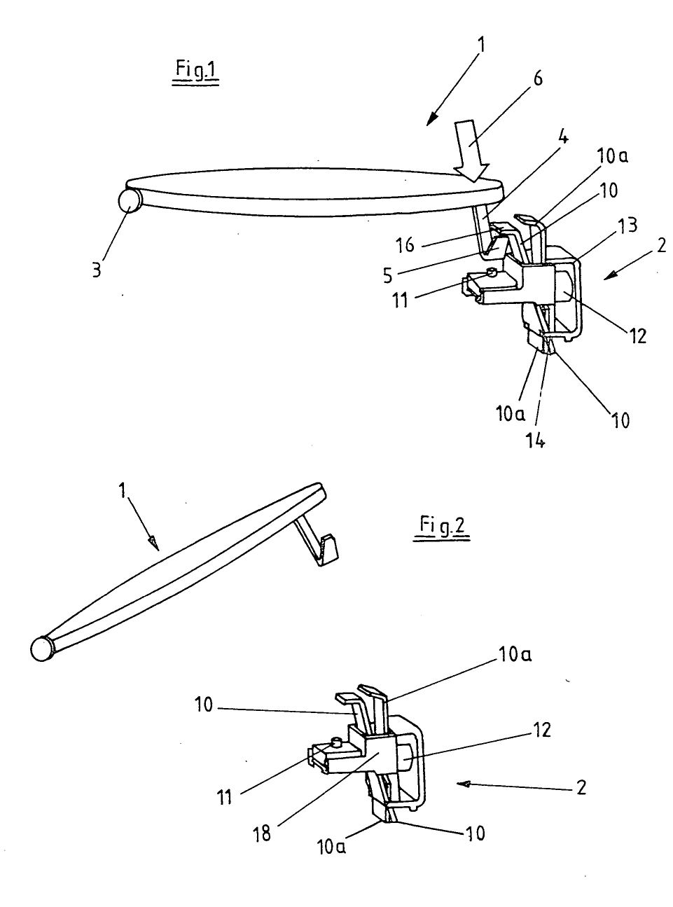

FIG. 2 represents flap 1 designed as a tank cap in the raised position. The locking element is again represented in both positions in locking device 2, i.e. both in locking position 10 as well as in release position 10a. Identical parts are marked with the same reference numbers.

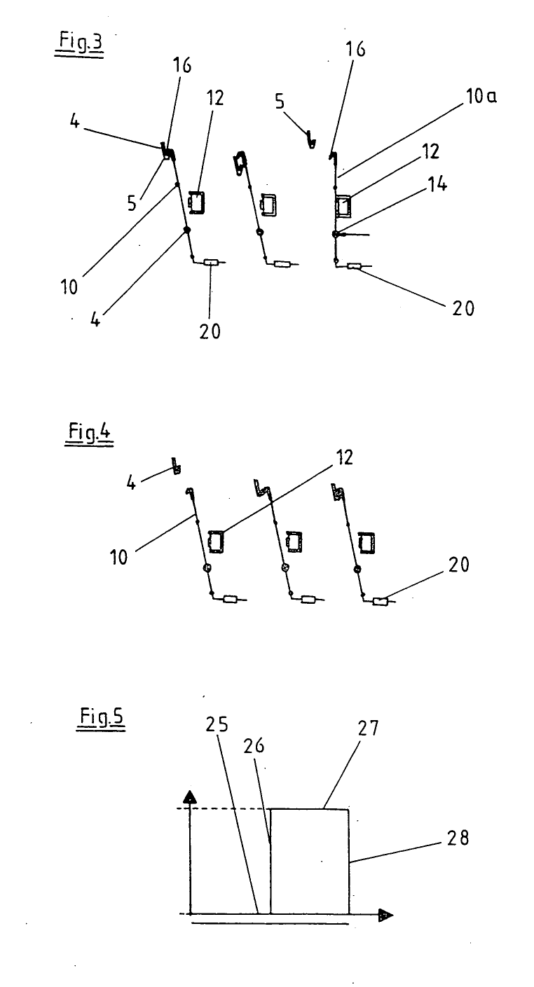

The motion sequence is further explained below by reference to the three positions represented in FIG. 3. The diagrammatic representation according to the first position in FIG. 3 corresponds to the representation in FIG. 1, whereby locking element 10 is in the locking position and locking pin 4 with its hook 5 engages in hook element 16 of locking element 10. Locking element 10 is held in the locking position by a spring device 20, which is arranged at the lower end of locking element 10, in particular beneath swivelling point 14. In the second position, as indicated by arrow 6 in FIG. 1, a pressure is exerted manually on the flap, so that locking pin 4 is pressed down and also operates there switch element 11 designed as a contact switch. Then, as represented in the third position in FIG. 3, actuator 12 is operated and pulls the locking element into the release position marked by 10a. Hook element 16 of locking element 10 is thus also pulled to the right in the Figure, so that flap 1, after termination of the pressure exerted manually, can swivel upwards about the axle running in mounting 3.

The closing process is explained with the aid of the three representations in FIG. 4. Actuator 12 is operated for only a short time and then switches off again, so that locking element 10 is in the locking position. When flap 1 is closed, locking pin 4 is guided downwards and, as can be seen in the second representation of FIG. 4, presses locking element 10 along the defined sliding surfaces to the side, until hook 5 and hook element 16 can latch into one another, or more precisely snap in or interlock.

The switching duration is represented in a diagram in FIG. 5. Time t is given on the x-axis and the switching status is plotted on the y-axis. In the first part of the represented curve, marked by 25, the actuator is switched off, since a predetermined pressing duration 25 must be present, in which locking pin 4 acts on switch element 11, so that a chance or unintentional contact can be distinguished from an intended opening. After locking pin 4 has acted on switch element 11 for the predetermined duration, actuator 12 is switched on at time point 26. Actuator 12 is then switched on for a predetermined duration 27, in which the locking element is in release position 10a. In the course of this duration, the operator must release the cap, or more precisely release the pressure on the cap, so that the cap can swing upwards. After the end of duration 27, the actuator switches off at time 28 and the locking element goes back, corresponding to the pull of spring device 20, into locking position 10. Predetermined pressing duration 25 corresponds in its temporal length roughly to predetermined duration 27, for which the actuator is actuated. This is because both durations are ultimately adapted to a conscious human action. The duration is approximately one second in each case.

Accordingly, while only a few embodiments of the present invention have been shown and described, it is obvious that many changes and modifications may be made thereunto without departing from the spirit and scope of the invention.

What is claimed is:

1. A method for unlocking a mobile element with a locking device having a mobile locking element interacting with the mobile element, the method comprising the following steps:
a) exerting a pressure on the mobile element in a direction of the locking device; and
b) moving the mobile element thereby triggered out of a locking position with the locking element, so that an interaction between the mobile element and the locking element is removed; and
c) operating a switch element caused by the exertion of pressure on the mobile element; and
d) moving the mobile locking element, triggered by the operation of the switch element, into a position in which no renewed locking takes place when the mobile element moves back, wherein the movement of the mobile locking element takes place while said mobile locking element is not in interaction with the mobile element, so that frictional and shearing forces are minimized.

2. The method according to claim 1, wherein in step c), the exertion of pressure takes place for a predetermined duration in order to operate the switch element.

3. The method according to claim 1, wherein the mobile element is held only for a predetermined duration in the position in which no renewed locking takes place during the return movement of the locking device.

4. The method according to claim 1, wherein a detection is carried out to establish whether the mobile element is locked or not in the locking device.

5. A locking device for a mobile element which can be in a closed or in an opened position, comprising:
a mobile locking element for locking the mobile element in the closed position, wherein when pressure is exerted on the mobile element, a mechanical contact between the locking element and the mobile element is removed,
a switch element actuated when pressure is exerted on the mobile element, and
an actuator in signal-connection with the switch element, so that the actuator is actuated when the switch element is operated, to change the locking element between a locking position and a release position.

6. The locking device according to claim 5, wherein the switch element is provided in the locking device and is in active connection with the mobile element and is positioned so that the switch element is actuated when pressure is exerted on the mobile element.

7. The locking device according to claim 5, further comprising a spring device for holding the locking element in the locking position, said spring device being assigned to the mobile locking element.

8. The locking device according to claim 5, wherein the actuator is in active connection with the locking element so that the actuator brings the locking element into the release position against a force applied by the spring device.

9. The locking device according to claim 5, wherein the actuator is activated for a predetermined duration when the switch element is operated, so that the locking element is in the release position for the predetermined duration.

10. The locking device according to claim 5, wherein the switch element is a contact switch.

11. The locking device according to claim 5, wherein the contact switch is connected with a circuit, which releases an activation signal for the actuator only after a predetermined duration of sustained pressure on the contact switch.

12. The locking device according to claim 11, wherein the circuit assigned to the contact switch is set to a predetermined duration, which corresponds approximately to the predetermined duration to which a circuit assigned to the actuator is set.

13. The locking device according to claim 7, wherein the locking device is designed in an assembly with the locking element, the spring device, the switch element and the actuator.

14. The locking device according to claim 5, wherein the actuator is in a circuit connection with a central locking.

15. The locking device according to claim 5, wherein the contact switch is positioned so that it can be operated by a locking pin arranged on the mobile element.

16. The locking device according to claim 5, wherein the mobile element is connected with a spring device which preloads the mobile element into an opened position.

17. A locking device according to claim 5, wherein the locking element is adapted to swivel about a point of rotation.

18. The locking device according to claim 7, wherein the locking element is connected in an end area with the spring device.

19. The locking device according to claim 5, wherein the locking element has a hook element in a free end area.

20. The locking device according to claim 5, wherein the hook element is designed for engagement in a locking pin fixed to the mobile element.

21. The locking device according to claim 5, wherein the locking pin has in its end area a hook, which slides along over defined sliding surfaces on the hook element of the locking element and interlocks with the locking element.

22. The locking device according to claim 5, wherein a sensor is provided, which detects whether the mobile locking element is in the locking or the release position.

23. The locking device according to claim 22, wherein the sensor is designed as a second contact switch or switch, which is provided in addition to the switch element and is triggered when the mobile locking element is in the locking position, wherein the switch element is triggered only when an additional pressure is exerted on the mobile locking element.
